(19) United States
(12) Patent Application Publication
(10) Pub. No.: US 2026/0263202 A1
(43) Pub. Date: Sep. 10, 2026

(54) DENTISTRY GOTHIC ARCH DEVICE

(71) Applicant: Timothy Chapel, Jackson, MI (US)

(72) Inventor: Timothy Chapel, Jackson, MI (US)

(21) Appl. No.: 19/562,280

(22) Filed: Mar. 10, 2026

Related U.S. Application Data
(60) Provisional application No. 63/769,236, filed on Mar. 10, 2025.

(51) Int. Cl. A61C 19/05

(52) U.S. Cl. CPC A61C 19/05

(57) ABSTRACT

A gothic arch device for recording occlusal vertical dimension and centric relation in a dental application includes a maxillary base having a striking plate coupled thereto and a mandibular base having a pair of support columns, each including a plurality of receivers oriented at different angles relative to an occlusal plane. An arch wire is selectively received within the plurality of receivers. A central bearing assembly is slidably mounted on the arch wire and includes a central bearing point and an adjustment mechanism for securing the central bearing assembly at a selected position along the arch wire. A placement plate is coupled to the striking plate at an apex of a gothic arch tracing pattern and includes a concave portion configured to receive the central bearing point to stabilize opposing baseplates at the occlusal vertical dimension with the temporomandibular joint in centric relation.

### CROSS-REFERENCE TO RELATED APPLICATIONS

This application claims the benefit of U.S. Provisional Application No. 63/769,236, filed on Mar. 10, 2025. The entire disclosure of the above application is incorporated herein by reference.

### FIELD

The present technology relates to a gothic arch device, and more specifically, a gothic arch device for recording a bite record and stabilizing a dental baseplate in a mouth.

### INTRODUCTION

This section provides background information related to the present disclosure which is not necessarily prior art.

A gothic arch device is a dentistry tool that provides a means to establish optimal support between a maxillary and a mandibular dental arch of a patient. When fitting a dental prosthetic, a dental professional faces challenges in accurately recording and reproducing the natural movement of the jaw of the patient. The human jaw exhibits complex motion patterns due to the connection of the jaw through moveable condyles in the glenoid fossae, with movement further influenced by ligaments, meniscus, and muscles. The interplay of the anatomical structures results in each patient having a distinctive three-dimensional envelope of motion that must be accurately captured to ensure optimal fit and function of dental appliances.

The gothic arch device can present several limitations in achieving stabilization. The initial settings of the device in relation to the sagittal, coronal, and transverse planes are made extra-orally, resulting in semi-arbitrary positioning that requires subsequent intraoral adjustment. The device can incorporate cross members that impede natural tongue positioning, potentially affecting the accuracy of bite registration. Additionally, when the lower cross member and upper striking plate are not optimally parallel to each other and the occlusal plane of the patient, uneven pressure develops on the baseplates.

There is a continuing need for a gothic arch device that allows for accurate, efficient, and user-friendly adjustment of the device relative to the sagittal, coronal, and transverse planes while maintaining optimal baseplate stabilization and promoting natural tongue positioning during the bite registration process.

### SUMMARY

In concordance with the instant disclosure, a gothic arch device that allows for accurate, efficient, and user-friendly adjustment of these planes while maintaining optimal baseplate stabilization and promoting natural tongue positioning during the bite registration process, has surprisingly been discovered. The present technology includes articles of manufacture, systems, and processes that relate to improving the accuracy and efficiency of a dental bite registration procedure for a patient. The present technology further provides a means of accurately capturing the occlusal vertical dimension of the patient with the temporomandibular joint in centric relation, thereby improving the predictability of denture fabrication and the functional and aesthetic outcomes of dental prosthetic treatment.

In certain embodiments, a gothic arch device for recording occlusal vertical dimension and centric relation in a dental application on an upper jaw and a lower jaw of a patient is provided. The gothic arch can include a maxillary base, a striking plate, a mandibular base, an arch wire, a central bearing assembly, and a placement plate. The maxillary base can be configured to fit against the upper jaw of the patient and can include an upper surface and a lower surface. The striking plate can be configured to be coupled to the lower surface of the maxillary base. The mandibular base can be configured to fit against a lower jaw of the patient and can include a pair of support columns disposed on opposing sides of the mandibular base. Each support column can include a plurality of receivers where each receiver of the plurality of receivers oriented at a different angle relative to an occlusal plane of the patient. The arch wire can include a pair of legs configured to be selectively received by a receiver of the plurality of receivers and a cross member connecting the pair of legs. The arch wire can include a central arched portion configured to pass over a tongue of the patient when positioned in the patient. The central bearing assembly can be slidably mounted on the arch wire and can include a central bearing point configured to contact the striking plate. The central bearing point can be positionable to align with a midline of a mandibular arch of the patient. The central bearing assembly can include an adjustment mechanism configured to secure the central bearing assembly at a selected position along the arch wire. The placement plate can be configured to be coupled to the striking plate at a predetermined position and can include an indentation configured to receive and retain the central bearing point.

In certain embodiments, a method of recording occlusal vertical dimension and centric relation of an upper jaw and a lower jaw of a patient is provided. The method can include providing the gothic arch device as described herein. The method can include coupling the striking plate to the lower surface of the maxillary base such that the striking plate is positioned at a predetermined distance above the occlusal plane of the patient. A marking substance can be applied to the contacting surface of the striking plate. The method can include inserting the arch wire, including the central bearing assembly mounted to the arch wire, into the support column such that the arch wire extends transversely across the mandibular base. The method can include positioning the maxillary base in the upper jaw of the patient and the mandibular base in the lower jaw of the patient. The position of the central bearing assembly can be adjusted along the arch wire to align the central bearing point with a midline of a mandibular arch of the patient. The method can include securing the central bearing assembly at the adjusted position using the adjustment mechanism. The lower jaw of the patient can be closed such that the central bearing point contacts the contacting surface of the striking plate. The method can include articulating the lower jaw to cause mandibular movement including moving the lower jaw forward and back, laterally to a right side and back to center, and laterally to a left side and back to center, wherein the central bearing point contacts and removes the marking substance from the striking plate during the mandibular movement to create a gothic arch tracing pattern having an apex. The placement plate can be coupled to the striking plate at a position corresponding to the apex of the gothic arch tracing pattern. The patient can close the lower jaw and the upper jaw such that the central bearing point sits within the indentation of the placement plate. The bite registration material can be placed between the maxillary base and the mandibular base and allowed to set to record the occlusal vertical dimension with a temporomandibular joint of the patient in centric relation.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a bottom plan view of a maxillary base of a gothic arch device;

FIG. 2 is a bottom plan view of the maxillary base including a striking plate;

FIG. 3 is a top plan view of a mandibular base of the gothic arch device;

FIG. 4 is a front, top perspective view of the mandibular base, an arch wire, and a central bearing assembly of the gothic arch device;

FIG. 5 is a front, top perspective of the mandibular base, the arch wire, and the central bearing assembly with the central bearing assembly shown in an off-center position;

FIG. 6 is a side elevational view of the mandibular base, the arch wire, and the central bearing assembly with the arch wire out of alignment with an occlusal plane of the patient;

FIG. 7A is a rear environment view of the gothic arch device installed in the mouth of the patient;

FIG. 7B is a front environment view of the gothic arch device installed in the mouth of the patient;

FIG. 7C is a side elevational environment view of the gothic arch device installed in the mouth of the patient;

FIG. 8 is a bottom plane view maxillary base with the striking place depicting a bite registration pattern for the patient;

FIG. 9 is a bottom plan view of the maxillary base with the striking plate depicting a bite registration pattern for the patient with a placement plate coupled to the striking plate;

FIG. 10 is a front perspective view of the gothic arch device after a bite registration process has taken place with a bite registration material coupled to the maxillary base and mandibular base to maintain the bite registration; and

FIG. 11 is a schematic depicting an occlusal plane relative to a wax rim;

FIGS. 12A-12D are a flowchart depicting a method of recording occlusal vertical dimension and centric relation of an upper jaw and a lower jaw of a patient.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1–10, or 2–9, or 3–8, it is also envisioned that Parameter X may have other ranges of values including 1–9, 1–8, 1–3, 1–2, 2–10, 2–8, 2–3, 3–10, 3–9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves the accuracy and predictability of stabilizing opposing baseplates in a mouth of a patient by providing a central bearing point on an arch wire disposed between maxillary and mandibular arches that maintains an occlusal vertical dimension during bite registration. The present technology improves upon certain gothic arch devices by militating against the need to preset planes that need to be overcome once in the mouth. To this end, the present technology provides greater tongue space by having the arch wire pass over the tongue rather than blocking it, thereby enabling easier and more efficient chairside adjustments to establish optimal parameters for accurate gothic arch tracing.

It should be appreciated that operation of a gothic arch device relies upon an occlusal plane (A) within the mouth of the patient. The occlusal plane (A) can be a reference point in denture construction that represents the theoretical plane formed by the meeting surfaces of the upper and the lower teeth. The occlusal plane (A) can include the bottom, horizontal surface of a wax rim which mimics the horizontal plane where the top and bottom teeth come together. In denture fittings, establishing the correct occlusal plane (A) affects both function and aesthetics as the occlusal plane (A) should align with the natural jaw movement of the patient while providing optimal lip support and incisal edge positioning. The gothic arch device 100 assists with establishing the occlusal plane (A) of the maxillary base, which can serve as the primary reference plane for the denture fabrication process. Once the occlusal plane (A) is established by the maxillary base, the mandibular base can be set relative to that established occlusal plane (A) when manufacturing the dentures, ensuring proper vertical dimension and alignment between the upper and lower dental prosthetics.

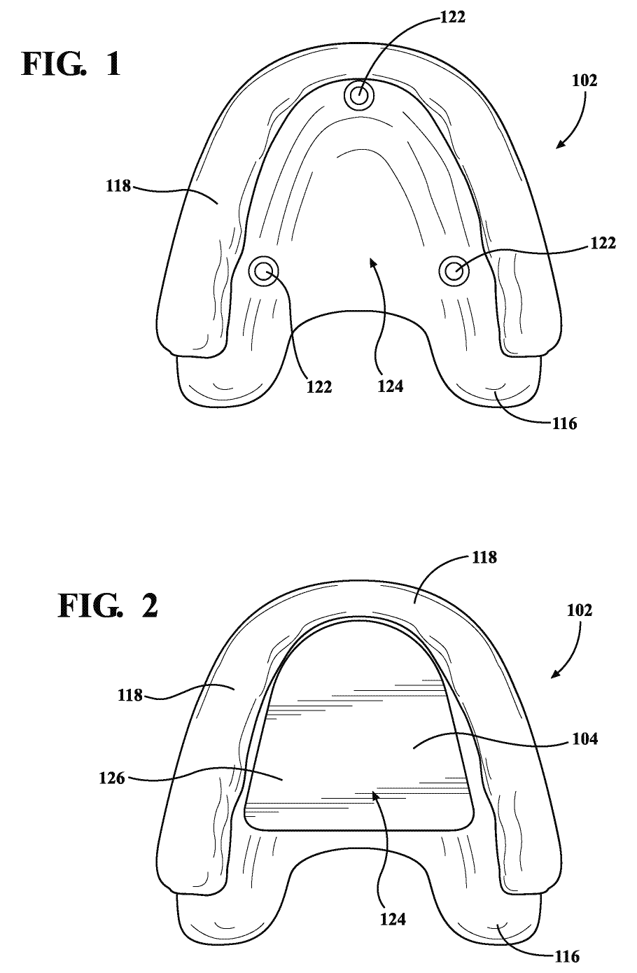

An embodiment of a gothic arch device 100 for dental applications is provided, as shown in FIGS. 1-11. The gothic arch device 100 can include a maxillary base 102, a striking plate 104, a mandibular base 106, an arch wire 108, a central bearing assembly 110, and a placement plate 112. Advantageously, the gothic arch device 100 provides improved accuracy in capturing an occlusal vertical dimension record of the patient through the adjustable components, which creates a more economical use of chairside time while delivering results in terms of record base stabilization and patient comfort.

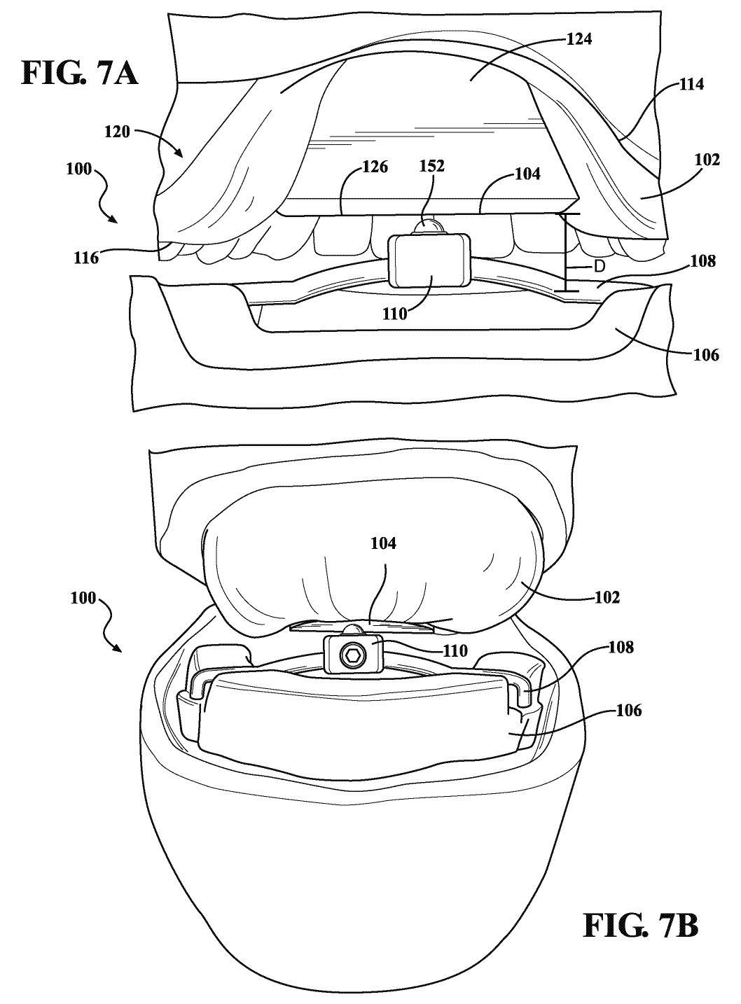

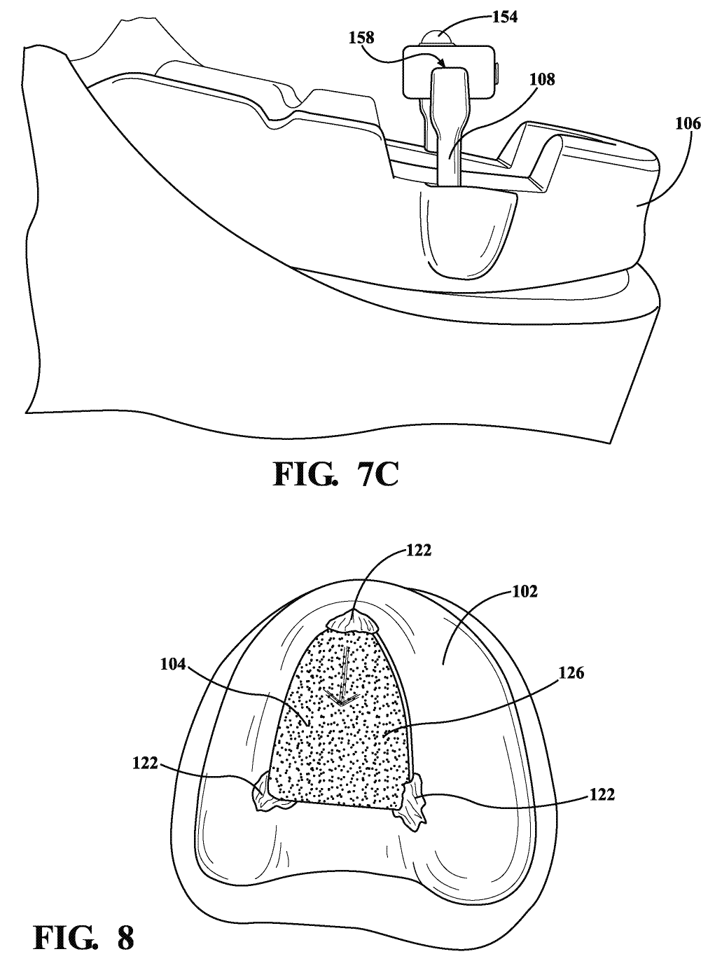

With reference to FIGS. 1-2, the gothic arch device 100 can include the maxillary base 102 configured to fit against the upper jaw of the patient. The maxillary base 102 can include an upper surface 114 that, when positioned in the mouth, contacts the upper jaw of the patient, and a lower surface 116 disposed adjacent a lower jaw of the patient. In certain embodiments, the maxillary base 102 can include a wax rim 118 that is coupled to the lower surface 116, as shown in FIG. 1. The shape and placement of the wax rim 118 on the maxillary base 102 can be adjusted chairside by a dental professional to represent three aspects of the dental anatomy of the patient: the occlusal plane (A), lip support, and an incisal edge position of the anterior teeth. The wax rim 118, shown in FIG. 7A, can act as a customizable surface that allows the dental professional to establish the orientation and positioning of the gothic arch device 100 before proceeding with a bite registration process, described herein.

To fit against the upper jaw of the patient, the maxillary base 102 can include a substantially arched shape configuration to correspond to the natural curvature of a dental arch of the patient. The arched configuration of the maxillary base 102 can mirror the anatomical contours of the maxillary ridge, allowing the maxillary base 102 to rest comfortably and securely within the mouth during the bite registration procedure. The arched configuration can ensure optimal positioning and stability of the gothic arch device 100 throughout operation.

In certain embodiments, the maxillary base 102 can include a channel 120 formed along the upper surface 114, allowing the maxillary base 102 to fit snugly around the contours of the upper jaw of the patient. The channel 120 can be configured to accommodate the unique ridge anatomy of each individual patient, providing enhanced retention and stability during jaw movements. The snug fit created by the channel 120 can militate against unwanted displacement or rocking of the maxillary base 102, thereby improving the accuracy of the bite registration. A skilled artisan can configure the channel 120 dimensions and profile to suit the specific anatomical requirements of the patient while maintaining the structural integrity of the maxillary base 102.

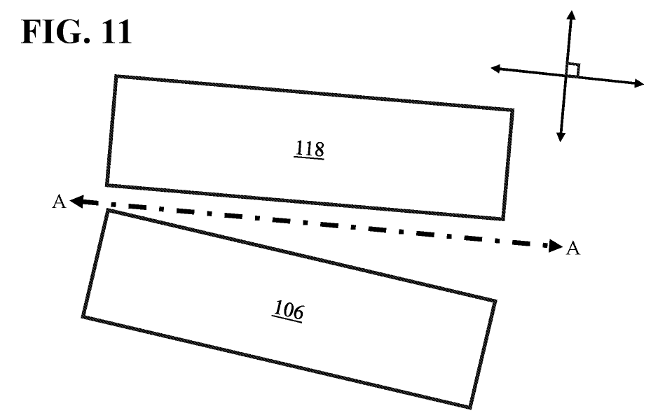

It should be appreciated that the present disclosure utilizes the maxillary base 102 with the wax rim 118 coupled to the lower surface 116 as one of the various components for establishing the occlusal plane (A), as shown in FIG. 11. However, in an alternative embodiment, a trial denture can be used in place of the maxillary base. The trial denture can be a mock-up version of a final denture for the patient and can be made of acrylic material, for example. The maxillary base 102 and trial denture can be interchangeable components in the gothic arch device 100, as both work within the operation of the gothic arch device 100 to determine bite registration and selection of the maxillary base 102 or the trial denture can be based on the personal preference of the user or dental professional. The ability to swap between the maxillary base 102 and the trial denture allows the dental professional to verify and adjust the bite registration at different stages of the denture fabrication process, providing flexibility during denture construction while maintaining the function of stabilizing the opposing baseplates in the mouth of the patient.

As shown in FIG. 1, the lower surface 116 of the maxillary base 102 can include a tab 122 configured to secure the striking plate 104 to the maxillary base 102. In certain embodiments, the maxillary base 102 can have more than one tab 122 for securing the striking plate 104, providing enhanced stability and optimal positioning. For example, as shown in FIG. 1, the maxillary base 102 can have three tabs 122 positioned on the lower surface 116 to receive the striking plate 104. Each tab 122 can function as an attachment point that allows the striking plate 104 to be coupled to the maxillary base 102 using wax, putty, or another suitable adhesive, for example, providing a secure yet removable connection that permits adjustment and repositioning as needed during the bite registration procedure.

The striking plate 104 can be positioned within an open space 124 formed by the maxillary base 102, which can be created by the substantially arched shape of the maxillary base 102 that mirrors the natural curvature of the dental arch. The arched configuration naturally creates a void or open area along the palatal region of the mouth where the striking plate 104 can be installed without interfering with the oral anatomy or natural tongue positioning. The striking plate 104 can be positioned at a predetermined distance (D), shown in FIG. 7A, above the occlusal plane (A). In certain embodiments, the striking plate 104 can be positioned between about 6 millimeters and about 10 millimeters above the occlusal plane (A). In a particular embodiment, the striking plate 104 can be positioned about 8 millimeters above the occlusal plane (A). A striking plate 104 depth guide can be used to accurately position the striking plate 104 parallel relative to the occlusal plane (A), ensuring sufficient clearance for the arch wire 108 to pass over the tongue of the patient during operation. The elevated positioning of the striking plate 104 allows for natural tongue placement and promotes patient comfort during the bite registration process. The striking plate 104 can include a contacting surface 126 adjacent to the arch wire 108 in operation. The contacting surface 126 can be configured to contact the central bearing assembly 110 of the arch wire 108 during jaw movements, providing a smooth, durable surface suitable for repeated contact and ink-based tracing.

During operation of the gothic arch device 100, the contacting surface 126 off the striking plate 104 can be coated with ink to record the range of motion of the jaw and create a gothic arch tracing. Before positioning the maxillary base 102 with the striking plate 104 in the mouth of the patient, the dental professional can cover the striking plate 104 with a dark marking substance such as ink, for example. As the patient performs mandibular movements consistent with the gothic arch tracing technique, the central bearing assembly 110 can contact the striking plate 104 and progressively remove the ink from the contacting surface 126. For this purpose, the striking plate 104 can be formed of metal. The metal composition can provide a smooth, rigid surface suitable for repeated contact with the central bearing assembly 110 during mandibular movements required during the bite registration process. As the patient performs functional jaw movements, including moving the mandible forward and back, out to the left and back, and out to the right and back, the central bearing assembly 110 can continuously contact and rub against contacting surface 126 of the striking plate 104. The durability and hardness of the surface militates against degradation, deformation, or wear during these repeated contacts, ensuring consistent performance throughout the tracing procedure. The striking plate 104 can be formed of various materials including metals such as stainless steel, aluminum, or other biocompatible metal alloys, and plastics, such as high-density polyethylene (HDPE), polypropylene, and acrylonitrile butadiene styrene (ABS), for example, commonly used in dental applications. A skilled artisan can select a suitable metal for the striking plate 104 within the scope of the present disclosure.

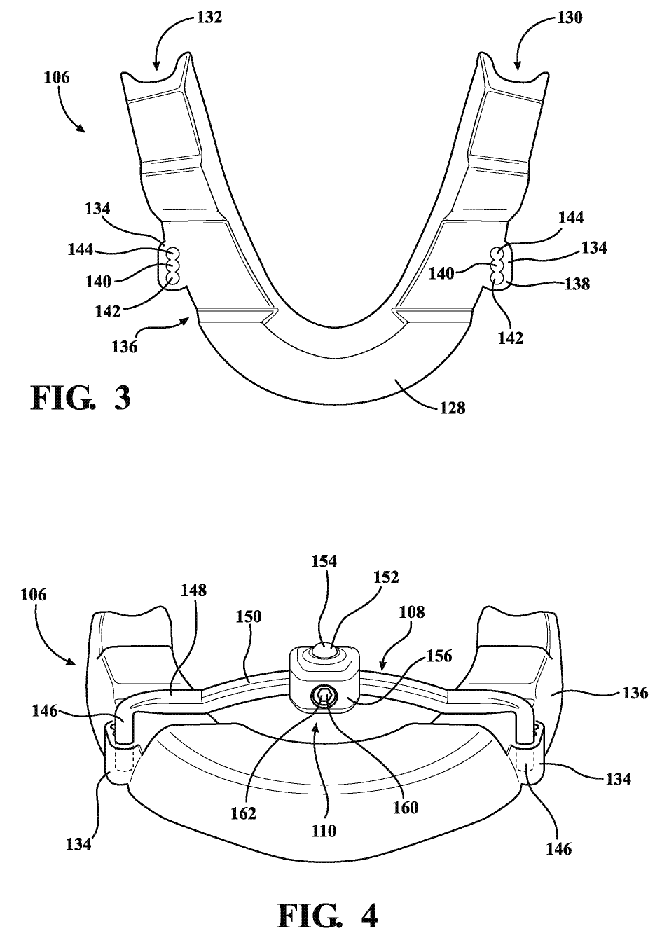

As shown in FIGS. 3-4, the mandibular base 106 can be configured to fit against the lower jaw of the patient and can be disposed adjacent to the maxillary base 102 when the gothic arch device 100 is positioned in the mouth. The mandibular base 106 can include an upper surface 128 and a lower surface 130, with the lower surface 130 contacting the lower jaw of the patient during operation. Similar to the maxillary base 102, the mandibular base 106 can be formed with a substantially arched shape configuration to correspond to the natural curvature of the mandibular dental arch, allowing the mandibular base 106 to rest comfortably and securely on the lower ridge. In certain embodiments, the mandibular base 106 can include a groove 132 formed along the lower surface 130 and configured to receive and fit snugly around the contours of the lower jaw of the patient, providing enhanced retention and stability during the bite registration procedure. It should be appreciated that the maxillary base 102 and the mandibular base 106 can be formed of a rigid material and can have a uniform thickness, such as about 3 millimeters, for example. A skilled artisan can select a suitable thickness and material for the maxillary base 102 and the mandibular base 106 within the scope of the present disclosure.

With continued reference to FIGS. 3-4, the mandibular base 106 can include a pair of support columns 134 positioned on opposing sides of the mandibular base 106. Each support column 134 can be disposed about at an intermediate point (e.g., halfway) along the mandibular base 106 on the cheek sides when in use. The positioning of the support columns 134 along an exterior portion 136 of the mandibular base 106 can provide positioning for receiving and anchoring the arch wire 108. The strategic placement of the support columns 134 on the sides of the mandibular base 106 allows for secure attachment of the arch wire 108 while maintaining clearance for the tongue and minimizing interference with oral anatomy and placing the arch wire 108 perpendicular to the occlusal plane (A).

Each support column 134 can include a receiver 138 and in certain embodiments, multiple receivers 138, configured to receive the arch wire 108. Each receiver 138 within the support columns 134 can be oriented at a different angle relative to the occlusal plane (A) of the patient. As shown in the embodiment depicted in FIGS. 3-4, each support column 134 can include three receivers 138, each disposed at a different angle to accommodate varying anatomical relationships between the mandibular arch and the occlusal plane (A). A first receiver 140 can be disposed in a plane (N) perpendicular to the occlusal plane (A), serving as the neutral or starting position for the arch wire 108. A second receiver 142 can in a plane (S) disposed at an angle of about positive 5-degrees to about positive 20-degress relative to the plane (N) of the first receiver 140, allowing forward adjustment of the arch wire 108, while a third receiver 144 can be in a plane (T) disposed at an angle of about negative 5-degrees to about negative 20-degress from the plane of the first receiver 140, enabling backward adjustment of the arch wire 108. In a particular embodiment, the second receiver 142 can in a plane (S) disposed at an angle of about positive 10-degrees t relative to the plane (N) of the first receiver 140, allowing forward adjustment of the arch wire 108, while a third receiver 144 can be in a plane (T) disposed at an angle of about negative 10-degrees from the plane of the first receiver 140. In a more particular embodiment, the second receiver 142 can in a plane (S) disposed at an angle of about positive 15-degrees t relative to the plane (N) of the first receiver 140, allowing forward adjustment of the arch wire 108, while a third receiver 144 can be in a plane (T) disposed at an angle of about negative 15-degrees from the plane of the first receiver 140. A skilled artisan can select a suitable number of receivers and angular orientations within the scope of the present disclosure.

In certain embodiments, each receiver 138 can be structurally distinct and independent from the other receiver 138 disposed within the support column 134. The receivers 138 can be configured such that each receiver 138 has a separate structural foundation that militates against overlap between the receivers 138 within each support column 134. The distinct separation of the receivers 138 provides stability for connection with the arch wire 108 when the arch wire 108 is received by the receiver 138. While the receiver 138 can remain divergent to accommodate angular adjustment of the arch wire 108, the structural independence of each receiver 138 militates against instability that could otherwise result from overlapping receiver structures, thereby improving the secure retention of the arch wire 108 during operation of the gothic arch device 100. In an alternative embodiment, the receivers 138 can be coformed as a unitary structure sharing overlapping portions, as shown in FIG. 3.

The receivers 138 disposed across the mandibular base 106 can be aligned within the same plane to allow the arch wire 108 to fit securely and optimally in the selected receivers 138 during operation. Each receiver 138 on one support column 134 can correspond to a receiver 138 on the opposing support column 134, with both corresponding receivers 138 oriented at the same angle relative to the occlusal plane (A). The corresponding alignment of the receivers 138 can facilitate optimal functioning of the gothic arch device 100. For example, where the angles of the receivers 138 are misaligned across the opposing support columns 134, the arch wire 108 can be tilted when installed. A tilted arch wire 108 can cause uneven pressure on the maxillary base 102 and the mandibular base 106 and compromise the parallel relationship between the mandibular base 106, the arch wire 108, and the central bearing assembly 110 which facilitates accurate bite registration. Where the arch wire 108 is misaligned due to non-corresponding receiver 138 angles, the central bearing assembly 110 cannot maintain consistent contact with the striking plate 104 during mandibular movements, rendering the gothic arch tracing inaccurate and unreliable for recording the centric relation and occlusal vertical dimension of the patient.

It should be appreciated that each receiver 138 disposed at different angles can account for the need to align the arch wire 108 perpendicular to the occlusal plane (A), which can facilitate optimal functioning of the gothic arch device 100 for bite registration. In operation, the arch wire 108 can be initially placed in the first receiver 140 that is perpendicular to the occlusal plane (A). Where the arch wire in the first receiver 140 is determined not to be perpendicular to the occlusal plane (A) established by the maxillary base 102, as shown in FIG. 6, the dental professional can reset the arch wire 108 by moving the arch wire 108 to the second receiver 142 or the third receiver 144. The adjustability of the arch wire 108 within the mandibular base 106 can promote optimal alignment of the arch wire 108 perpendicular to the occlusal plane (A). When the arch wire 108 and the striking plate 104 are not optimally parallel to each other and the occlusal plane (A) of the patient, uneven pressure can develop on the maxillary base 102 and mandibular base 106, compromising the accuracy of the bite record. The ability to make adjustments to the angle of the arch wire 108 intraorally, rather than through extraoral presetting, provides greater accuracy and efficiency in establishing the correct spatial relationships necessary for reliable bite registration.

Turning now to FIG. 4, the arch wire 108 can be configured to span across the mandibular base 106 and provide a stable, adjustable support structure for the central bearing assembly 110 during the bite registration procedure. The arch wire 108 can include a pair of legs 146 and a cross member 148 connecting the pair of legs 146. Each leg 146 of the pair of legs 146 can be configured to be selectively received within one of the first receiver 140, the second receiver 142, and the third receiver 144 on each support column 134 of the mandibular base 106. The selective engagement of the legs 146 within the receivers 138 allows the arch wire 108 to be repositioned among the available receivers 138 intraorally to achieve optimal angular alignment relative to the occlusal plane (A) of the patient, as described herein.

The cross member 148 connecting the pair of legs 146 can include a central arched portion 150 configured to pass over the tongue of the patient when the gothic arch device 100 is positioned in the mouth. The central arched portion 150 can extend upwardly from the pair of legs 146 in a curved configuration that clears the dorsal surface of the tongue, allowing the tongue to rest in a natural position during the bite registration procedure. Advantageously, the arched configuration of the cross member 148 militates against interference with natural tongue positioning that can otherwise compromise the accuracy of bite registration.

The arch wire 108 can be formed of a rigid, biocompatible material suitable for intraoral use. In certain embodiments, the arch wire 108 can be formed of a metal such as stainless steel, titanium, or other biocompatible metal alloys, or polymer resin, used in dental applications. The material composition of the arch wire 108 can provide sufficient rigidity to support the central bearing assembly 110 and maintain the central bearing point 152 in consistent contact with the striking plate 104 during mandibular movements of the patient, while also providing the necessary durability to withstand repeated repositioning among the receivers 138. The striking plate 104 can help visualize the centering of the central bearing point 152 with a midline of the mandibular arch of the patient. A skilled artisan can select a suitable material and cross-sectional dimension for the arch wire 108 within the scope of the present disclosure.

It should be appreciated that the gothic arch device 100 can include a plurality of arch wires 108 of varying leg lengths to accommodate different vertical dimensions of occlusion among patients. In certain embodiments, the plurality of arch wires 108 can differ in leg length by about two millimeters per arch wire 108. One arch wire 108 of the plurality of arch wires 108 can represent a leg length corresponding to an average vertical dimension of occlusion of an adult patient, with additional arch wires 108 available having leg lengths longer and shorter than the average. The availability of multiple arch wires 108 of varying lengths allows the dental professional to select or substitute an arch wire 108 of appropriate leg length to establish or modify the vertical dimension of occlusion of the patient chairside. Where the dental professional determines that an adjustment to the vertical dimension is required, the arch wire 108 can be replaced with an arch wire 108 having a longer or shorter leg length as appropriate, and the central bearing assembly 110 can be transferred to the replacement arch wire 108 and repositioned at the midline of the mandibular arch of the patient prior to continuing the bite registration procedure.

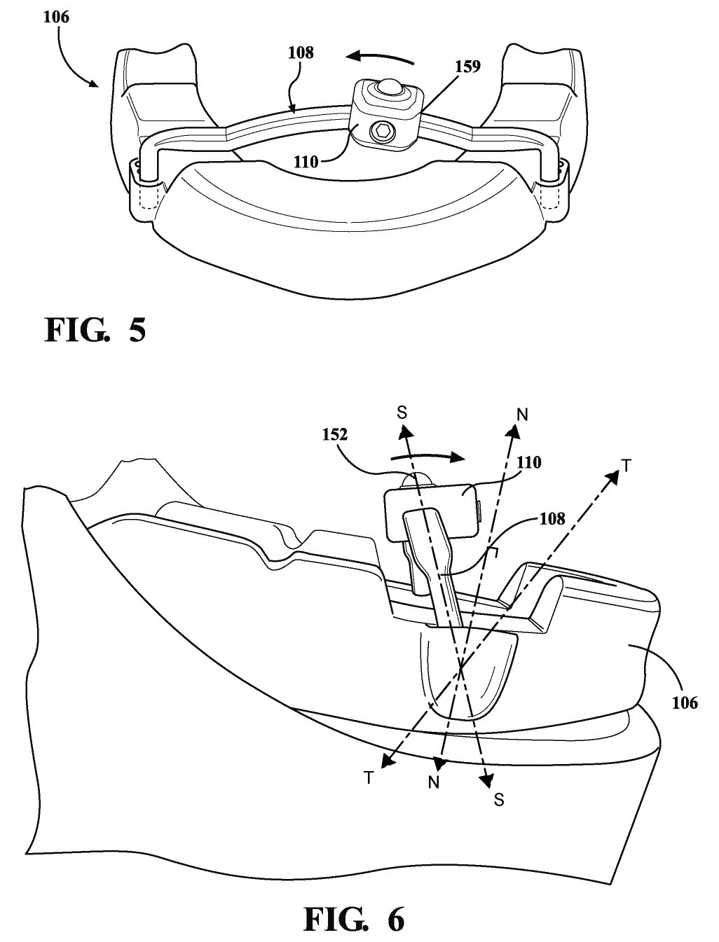

With reference to FIGS. 4-5, the central bearing assembly 110 can be slidably mounted on the arch wire 108, providing adjustability for optimal positioning during the bite registration procedure. The central bearing assembly 110 can slide freely over the arch wire 108, allowing lateral movement of the central bearing assembly 110 for alignment with the midline of the mandibular arch of the patient. The slidable nature of the central bearing assembly 110 can enable chairside adjustments to be made intraorally once the gothic arch device 100 is positioned in the mouth of the patient, militating against the need for extraoral presetting and associated inaccuracies that can arise when components are positioned outside the oral environment.

The central bearing assembly 110 can include a central bearing point 152 configured to contact the striking plate 104 during operation of the gothic arch device 100. In certain embodiments, the central bearing point 152 can be configured as a rotating ball bearing 154 that provides a smooth, consistent point of contact with the striking plate 104. The ball bearing 154 configuration allows the central bearing point 152 to move freely across the contacting surface 126 of the striking plate 104 as the patient performs mandibular movements during the gothic arch tracing procedure. The configuration of the ball bearing 154 can be advantageous as the rotating nature permits multidirectional movement without resistance or snagging, allowing the patient to execute the forward and back, left and back, and right and back movements required for gothic arch tracing. During operation, when the striking plate 104 is coated with ink or a dark marking substance, the rotating ball bearing 154 can progressively remove the ink as the ball bearing 154 traces across the contacting surface 126, creating the characteristic arrow-shaped gothic arch pattern that indicates the range of motion and centric relation position. The point of the arrow formed by the gothic arch tracing, shown in FIG. 8, represents the most posterior point of functional movement where the condyle and fossa are in a functionally seated position, which corresponds to the centric relation that the dental professional seeks to record. The ball bearing 154 thus serves a dual function by providing stable vertical support between the maxillary base 102 and the mandibular base 106 while simultaneously creating a visual record of the functional movements of the jaw through the ink removal tracing process.

The central bearing assembly 110 can have a rigid body 156 with a bearing channel 158 formed therethrough that receives the arch wire 108 and allows the central bearing assembly 110 to move along the arch wire 108 via an entry/exit point 159 of the central bearing assembly, as shown in FIG. 5. The rigid body 156 can function as a collar or slide component that surrounds the arch wire 108, creating a secure engagement while permitting lateral movement for adjustment during operation. The bearing channel 158 can be sized and configured to receive the arch wire 108 with sufficient clearance to allow smooth sliding movement when the central bearing assembly 110 is not secured, while maintaining enough contact to ensure stability and militate against unwanted play or wobble during operation. A skilled artisan can select suitable dimensions for the bearing channel 158 based on the cross-sectional dimensions of the arch wire 108 to achieve the desired balance between slidability and stability.

The central bearing assembly 110 can further include an adjustment mechanism 160 configured to secure the central bearing assembly 110 at a selected position along the arch wire 108 and allow for the repositioning of the central bearing assembly 110 along the arch wire 108 for alignment. The adjustment mechanism 160 can allow the dental professional to position and stabilize the central bearing point 152 at the midline of the mandibular arch of the patient. The central bearing assembly 110 can include an aperture 162 configured to receive the adjustment mechanism 160, providing a point of engagement between the adjustment mechanism 160 and the rigid body 156. The aperture 162 can extend through the rigid body 156 to allow the adjustment mechanism 160 to contact the arch wire 108 when tightened. In certain embodiments, the adjustment mechanism 160 can be a set screw, bolt, or similar fastening device that extends through the aperture 162 and applies pressure against the arch wire 108. In certain embodiments, the aperture 162 can be a set screw threadedly engaged with the aperture 162 in the rigid body 156 such that rotation of the set screw causes the set screw to advance inward toward the arch wire 108. When tightened, the set screw can create friction between the rigid body 156 and the arch wire 108 by applying direct pressure to the surface of the arch wire 108, holding the central bearing assembly 110 securely in place on the arch wire 108 at the desired position. The frictional engagement can militate against the central bearing assembly 110 from shifting or sliding along the arch wire 108 during the bite registration process, ensuring that the central bearing point 152 maintains alignment with the midline throughout the gothic arch tracing procedure. Conversely, when the set screw is loosened, the pressure on the arch wire 108 can be released, allowing the central bearing assembly 110 to move freely left or right along the arch wire 108 for repositioning. The adjustability enables chairside corrections to align the central bearing point 152 with the midline of the mandibular arch, promoting optimal contact with the striking plate 104 during the bite registration process.

It should be appreciated that the central bearing assembly 110 must be positioned correctly relative to the occlusal plane (A) and the midline of the mandibular arch to ensure optimal functioning of the gothic arch device 100. The central bearing point 152 can be preset to the midline of the mandibular arch of the patient prior to positioning the device 100 in the mouth. Once the gothic arch device 100 is placed in the mouth, the dental professional can evaluate whether the central bearing point 152 contacts the striking plate 104 at the midline when the patient gently closes the maxillary base 102 and the mandibular base 106 together. If the central bearing point 152 is not aligned with the midline, adjustments can be made chairside by loosening the adjustment mechanism 160, moving the central bearing assembly 110 left or right along the arch wire 108 until the ball bearing 154 touches the striking plate 104 at the midline, and then tightening the adjustment mechanism 160 to secure the central bearing assembly 110 in the corrected position. The process of centering the central bearing point involves first identifying the off-center position, as shown in FIG. 5, then adjusting the central bearing assembly 110 laterally until optimal midline alignment is achieved. The ability to make these adjustments intraorally rather than through extraoral presetting provides greater accuracy because the dental professional can directly observe and verify the contact between the ball bearing 154 and the striking plate 104 while the gothic arch device 100 is positioned in the mouth of the patient.

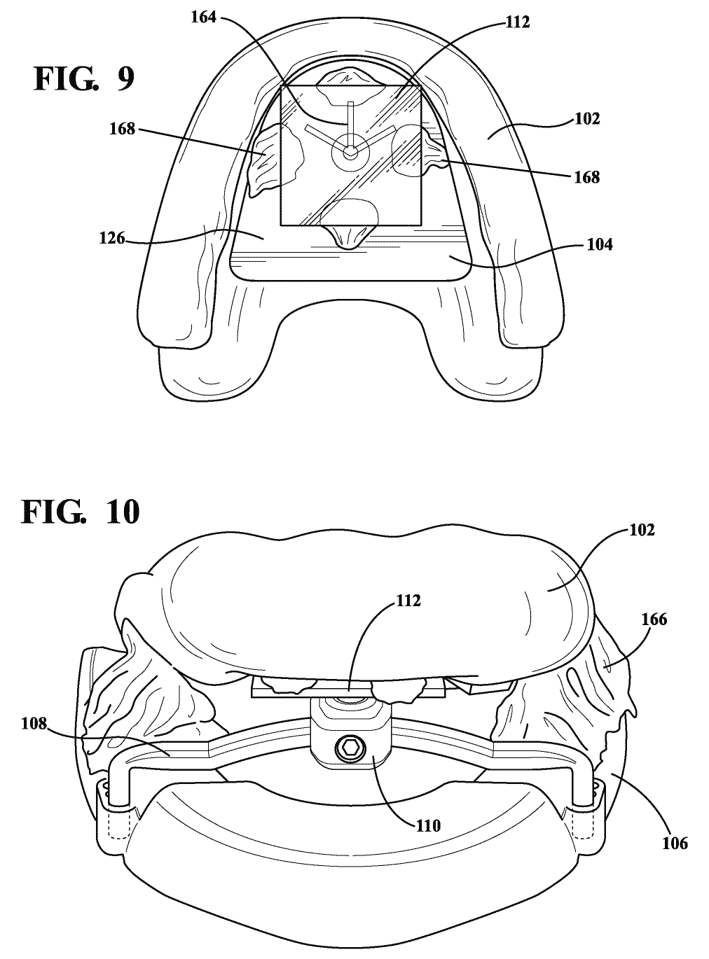

With reference FIG. 9, the placement plate 112 operates as an anchoring component that provides a contact point for the central bearing assembly 110 during the gothic arch tracing procedure. After the patient completes the mandibular movements that create the characteristic arrow pattern on the striking plate 104, as shown in FIG. 8, the placement plate 112 can be adhered to the striking plate 104 at the apex of the arrow, which represents the most posterior point of functional movement where the condyle and fossa are in a functionally seated position. The positioning of the placement plate 112 can ensure that subsequent bite registration captures the jaw in centric relation.

The placement plate 112 can be positioned on the contacting surface 126 of the striking plate 104 such that the placement plate 112 interfaces directly with the ball bearing 154 of the central bearing point 152. The striking plate 104 can be coupled to the lower surface 116 of the maxillary base 102. The placement plate 112 can be affixed to the striking plate 104 at the point where the gothic arch tracing indicates optimal condylar positioning, creating a stable reference point for maintaining the predetermined vertical dimension during bite registration.

The placement plate 112 can include a ring-like indentation 164 centrally disposed on surface opposite a surface that couples with the striking plate 104. The ring-like indentation 164 can receive and cradle the ball bearing 154 of the central bearing assembly 110. The ring-like indentation 164 can allow the spherical ball bearing 154 to seat securely within the placement plate 112, militating against lateral displacement during the bite registration process while the patient maintains jaw closure. The ring-like indentation 164 provides three-dimensional stability by conforming to the curvature of the ball bearing 154.

The placement plate 112 can be affixed to the strike plate 104 using an adhesive 168 such as wax. Once positioned, the ball bearing 154 rests within the indentation 164 of the placement plate 112, and bite registration material 166 can be placed between the maxillary base 102 and the mandibular base 106 while the patient maintains closure with the ball bearing 154 seated in the placement plate 112. The configuration stabilizes the opposing maxillary base 102 and mandibular base 106 and captures the occlusal vertical dimension with the temporomandibular joint in centric relation.

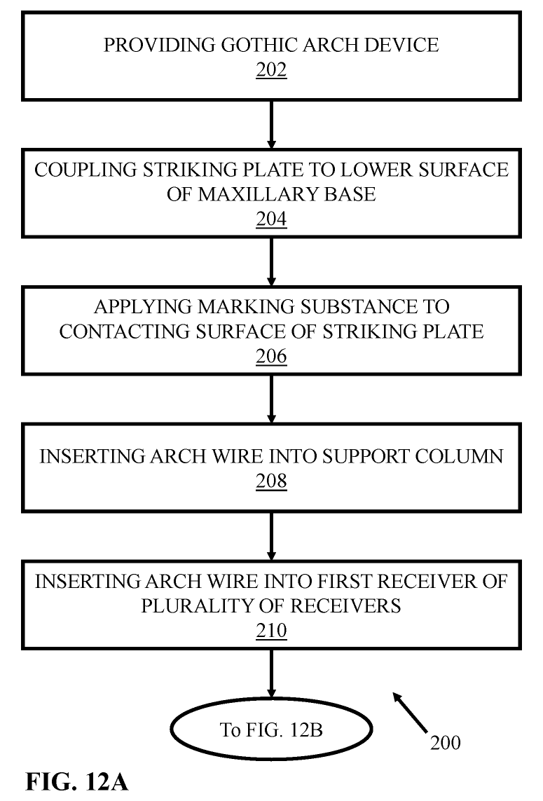

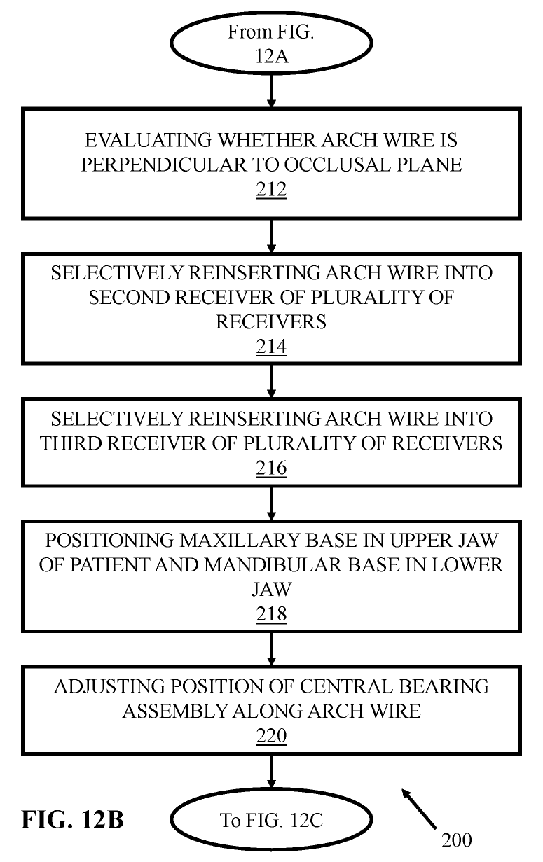

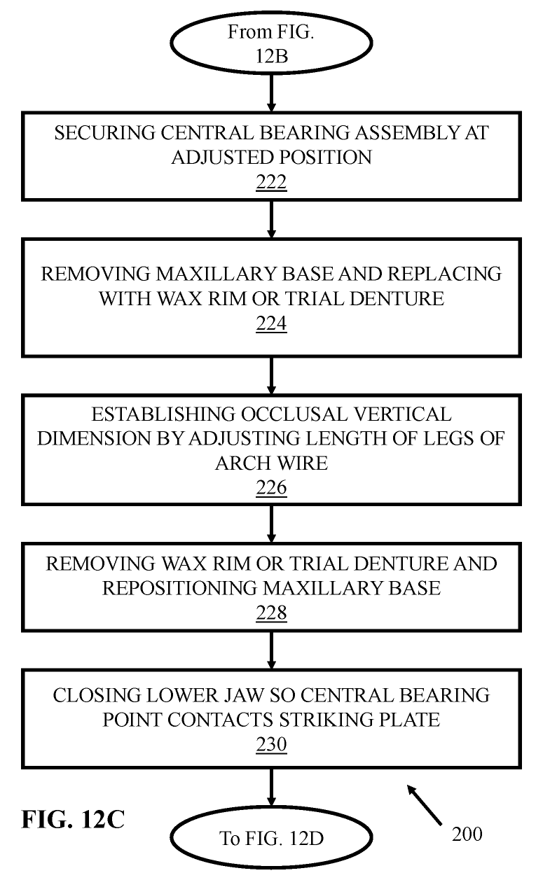

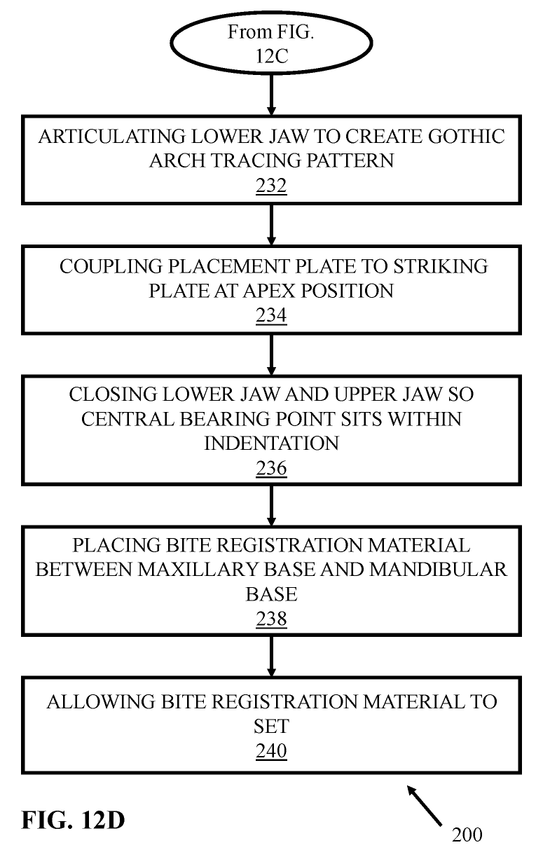

The present disclosure further provides a method 200 of recording occlusal vertical dimension and centric relation of an upper jaw and a lower jaw of a patient, shown generally in FIGS. 12A-12D. The method 200 can include a step 202 of providing the gothic arch device 100 as described herein. In a step 204, the method 200 can include coupling the striking plate 104 to the lower surface 116 of the maxillary base 102 such that the striking plate 104 is positioned parallel to the occlusal plane (A) of the patient. A marking substance can be applied to the contacting surface 126 of the striking plate 104 in a step 206. The method 200 can include a step 208 of inserting the arch wire 108, including the central bearing assembly 110 mounted to the arch wire 108, into the support column 134 such that the arch wire 108 extends transversely across the mandibular base 106.

The step 208 of inserting the arch wire 108 into the mandibular base 106 can further include a step 210 of inserting the arch wire 108 into the first receiver 140 oriented in a plane perpendicular to the occlusal plane (A). The step 208 can also include a step 212 evaluating, with the maxillary base 102 and the mandibular base 106 positioned in the mouth of the patient, whether the arch wire 108 is perpendicular to the occlusal plane (A) established by the maxillary base 102. The method 200 can include a step 214 of selectively reinserting the arch wire 108 into the second receiver 142 when the arch wire 108 is determined not to be perpendicular to the occlusal plane (A). It should be appreciated that the second receiver 142 can be oriented at about positive 15 degrees relative to the first receiver 140 to angularly adjust the arch wire 108 in a forward direction. In a step 216, the method 200 can include selectively reinserting the arch wire 108 into the third receiver 144 when the arch wire 108 is determined not to be perpendicular to the occlusal plane (A). It should be appreciated that the third receiver 144 can be oriented at about negative 15 degrees relative to the first receiver 140 to angularly adjust the arch wire 108 in a back direction. For this purpose, the arch wire 108 can be inserted among the first receiver 140, the second receiver 142, and the third receiver 144 until the arch wire 108 is perpendicular to the occlusal plane (A) of the patient.

The method 200 can include a step 218 of positioning the maxillary base 102 in the upper jaw of the patient and the mandibular base 106 in the lower jaw of the patient. The position of the central bearing assembly 110 can be adjusted along the arch wire 108 to align the central bearing point 152 with a midline of a mandibular arch of the patient in a step 220. In a step 222, the method can include securing the central bearing assembly 110 at the adjusted position using the adjustment mechanism 160.

In a step 224, the maxillary base 102 can be removed from the upper jaw and replaced with a wax rim or trial denture having a striking plate positioned at the same location as the striking plate 104 of the maxillary base 102 using tabs 122. The method 200 can include a step 226 of establishing occlusal vertical dimension by adjusting a length of legs of the arch wire 108 based on evaluation of facial profile for esthetics and function, wherein the wax rim 118 or trial denture establishes lip support and incisal edge position and the mandibular base 106 establishes lower lip support. In a step 228, the wax rim or trial denture can be removed from the upper jaw and the maxillary base 102 with striking plate 104 can be repositioned in the upper jaw for gothic arch tracing and bite registration.

The lower jaw of the patient can be closed such that the central bearing point 152 contacts the contacting surface 126 of the striking plate 104 in a step 230 and depicted in FIGS. 7A-7C. The method 200 can include a step 232 of articulating the lower jaw to cause mandibular movement including moving the lower jaw forward and back, laterally to a right side and back to center, and laterally to a left side and back to center, wherein the central bearing point 152 contacts and removes the marking substance from the striking plate 104 during the mandibular movement to create a gothic arch tracing pattern having an apex. In a step 234, the placement plate 112 can be coupled to the striking plate 104 at a position corresponding to the apex of the gothic arch tracing pattern.

In a step 236, the patient can close the lower jaw and the upper jaw such that the central bearing point 152 sits within the indentation 164 of the placement plate 112. The bite registration material 166 can be placed between the maxillary base 102 and the mandibular base 106 in a step 238, wherein upper surface of the mandibular base 106 is positioned below the occlusal plane (A) to the lower surface of the wax rim 118 or trial denture when establishing vertical dimension, and the maxillary base 102 during recording of the tracing. The bite registration material 166 can be allowed to set to record the occlusal vertical dimension with a temporomandibular joint of the patient in centric relation in a step 240.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A gothic arch device for recording occlusal vertical dimension and centric relation in a dental application on an upper jaw and a lower jaw of a patient and accommodate a tongue and a mandibular arch of the patient, comprising:
a maxillary base configured to fit against the upper jaw of the patient, the maxillary base including an upper surface and a lower surface;
a striking plate configured to be coupled to the lower surface of the maxillary base;
a mandibular base configured to fit against a lower jaw of the patient, the mandibular base including a pair of support columns disposed on opposing sides of the mandibular base, each support column including a plurality of receivers, each receiver of the plurality of receivers oriented at a different angle relative to an occlusal plane of the patient;
an arch wire including a pair of legs configured to be selectively received by a receiver of the plurality of receivers and a cross member connecting the pair of legs and including a central arched portion configured to pass over the tongue of the patient when positioned in the patient;
a central bearing assembly slidably mounted on the arch wire and including a central bearing point configured to contact the striking plate and positionable to align with a midline of the mandibular arch of the patient, and an adjustment mechanism configured to secure the central bearing assembly at a selected position along the arch wire; and
a placement plate configured to be coupled to the striking plate at a predetermined position and including an indentation configured to receive and retain the central bearing point.

2. The gothic arch device of claim 1, wherein the lower surface of the maxillary base includes a tab configured to secure the striking plate to the maxillary base.

3. The gothic arch device of claim 2, wherein tab includes three tabs positioned on the lower surface of the maxillary base.

4. The gothic arch device of claim 1, wherein the striking plate is positioned at a distance of between 6 millimeters and 10 millimeters above the occlusal plane.

5. The gothic arch device of claim 1, wherein the striking plate is positioned at a distance of 8 millimeters above the occlusal plane.

6. The gothic arch device of claim 1, wherein the striking plate includes a contacting surface configured to be coated with a marking substance to record a range of motion of the lower jaw of the patient during a bite registration procedure.

7. The gothic arch device of claim 6, wherein the central bearing point includes a rotating ball bearing configured to provide contact with the contacting surface of the striking plate during mandibular movements of the patient.

8. The gothic arch device of claim 1, wherein each support column of the pair of support columns is disposed at an intermediate point along an anterior-posterior length of the mandibular base.

9. The gothic arch device of claim 1, wherein the plurality of receivers of each support column includes a first receiver, a second receiver, and a third receiver.

10. The gothic arch device of claim 9, wherein each of the first receiver, the second receiver, and the third receiver is oriented at a different angle relative to the occlusal plane.

11. The gothic arch device of claim 9, wherein the first receiver is disposed in a plane perpendicular to the occlusal plane.

12. The gothic arch device of claim 9, wherein the second receiver is disposed at angle of positive 15 degrees relative to a plane of the first receiver to allow forward angular adjustment of the arch wire.

13. The gothic arch device of claim 9, wherein the third receiver is disposed at an angle of negative 15 degrees relative to a plane of the first receiver to allow rearward angular adjustment of the arch wire.

14. The gothic arch device of claim 1, wherein each receiver of the plurality of receivers on one support column of the pair of support columns corresponds to a receiver on the opposing support column of the pair of support columns, with each pair of corresponding receivers oriented at a same angle relative to the occlusal plane.

15. The gothic arch device of claim 1, wherein the central bearing assembly includes a rigid body having a bearing channel formed therethrough configured to receive the arch wire and allow the central bearing assembly to slide along the arch wire.

16. The gothic arch device of claim 1, wherein the placement plate is configured to be affixed to the striking plate using an adhesive at a position corresponding to an apex of a gothic arch tracing pattern formed on the striking plate during a bite registration procedure.

17. The gothic arch device of claim 1, further including a trial denture configured to couple with the striking plate via a plurality of tabs positioned on the trial denture at locations corresponding to tab locations on the maxillary base, wherein the maxillary base is interchangeable with the trial denture.

18. The gothic arch device of claim 1, further including a bite registration material configured to be placed between the maxillary base and the mandibular base while the central bearing point is seated within the indentation of the placement plate to capture a spatial relationship between the maxillary base and the mandibular base corresponding to the occlusal vertical dimension of the patient.

19. A method of recording occlusal vertical dimension and centric relation of an upper jaw and a lower jaw of a patient, comprising:
providing the gothic arch device of claim 1;
articulating the lower jaw to cause mandibular movement including moving the lower jaw forward and back, laterally to a right side and back to center, and laterally to a left side and back to center, wherein the central bearing point contacts and removes a marking substance from the striking plate during the mandibular movement to create a gothic arch tracing pattern having an apex.

20. The method of claim 19, wherein inserting the arch wire into a selected receiver of the plurality of receivers further includes steps of:
inserting the arch wire into a first receiver of the plurality of receivers, the first receiver oriented in a plane perpendicular to the occlusal plane;
evaluating, with the maxillary base and the mandibular base positioned in a mouth of the patient, whether the arch wire is perpendicular to the occlusal plane established by the maxillary base;
selectively reinserting the arch wire into a second receiver of the plurality of receivers when the arch wire is determined not to be perpendicular to the occlusal plane, the second receiver oriented at 15 degrees relative to the first receiver to angularly adjust the arch wire in a forward direction; and
selectively reinserting the arch wire into a third receiver of the plurality of receivers when the arch wire is determined not to be perpendicular to the occlusal plane, the third receiver oriented at negative 15 degrees relative to the first receiver to angularly adjust the arch wire in a rearward direction;
wherein the arch wire is reinserted among the first receiver, the second receiver, and the third receiver until the arch wire is perpendicular to the occlusal plane of the patient.
